(19) United States
(12) Patent Application Publication
(10) Pub. No.: US 2025/0199750 A1
(43) Pub. Date: Jun. 19, 2025

(54) PERCEPTUAL ALGORITHMS AND DESIGN INTERFACE TO SAVE DISPLAY POWER

(71) Applicant: Meta Platforms Technologies, LLC, Menlo Park, CA (US)

(72) Inventors: Alexandre CHAPIRO, San Carlos, CA (US); Kenneth CHEN, New York, NY (US); Ajit NINAN, San Jose, CA (US); Romain BACHY, Seattle, WA (US); James HILLIS, Bloomington, IN (US); Chun Chi WAN, San Jose, CA (US); Nathan MATSUDA, Seattle, WA (US)

(21) Appl. No.: 18/976,005

(22) Filed: Dec. 10, 2024

Related U.S. Application Data
(60) Provisional application No. 63/609,634, filed on Dec. 13, 2023.

(51) Int. Cl. G06F 3/147; G06T 5/60

(52) U.S. Cl. CPC G06F 3/147; G06T 5/60; G06T 2200/24; G06T 2207/10016; G06T 2207/20081; G06T 2207/20084

(57) ABSTRACT

Techniques disclosed herein relate generally to modifying images to reduce display power while maintaining visual fidelity of the displayed images. In one example, a computer-implemented method includes receiving an input image to be displayed by a type of display device, obtaining a machine learning model that is trained to edit display content to reduce power consumption of displaying the edited display content by the type of display device while maintaining a visual fidelity of the edited display content, applying the machine learning model to the input image to generate an output image, and displaying the output image via a display device of the type of display device.

### CROSS-REFERENCE TO RELATED APPLICATION

This application claims the benefit of and priority to U.S. Provisional Application No. 63/609,634, filed Dec. 13, 2023, entitled “PERCEPTUAL ALGORITHMS AND DESIGN INTERFACE TO SAVE DISPLAY POWER,” which is hereby incorporated by reference in its entirety for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 10 to 20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)), and the surrounding environment by, for example, seeing through transparent display glasses or lenses (often referred to as optical see-through) or viewing displayed images of the surrounding environment captured by a camera (often referred to as video see-through). The image of a near-eye display may be generated using, for example, a liquid crystal display (LCD), an organic light emitting diode (OLED) display, a micro-OLED display, an inorganic light emitting diode (ILED) display, a micro light emitting diode (micro-LED) display, an active-matrix OLED display (AMOLED), a transparent OLED display (TOLED), a laser-based display device, a digital light processing (DLP) display device, or some other displays. It is generally desirable that the near-eye display has a small size, a low weight, a large field of view, a large eye box, a high efficiency, a high brightness, a high resolution, a high refresh rate, and a low cost.

### SUMMARY

This disclosure relates generally to head-mounted displays or other near-eye displays. More specifically, and without limitation, techniques disclosed herein relate to machine learning models and design tools for designing display content to save power while maintaining good visual fidelity in head-mounted display, based on combined or unified display content perceptual and power analysis techniques. Various inventive embodiments are described herein, including systems, methods, processes, algorithms, applications, program code, machine learning models, neural networks, design tools, user interfaces, and the like.

According to certain embodiments, a computer-implemented method may include receiving an input image to be displayed by a type of display device, obtaining a machine learning model that is trained to edit display content to reduce power consumption of displaying the edited display content by the type of display device while maintaining a visual fidelity of the edited display content, applying the machine learning model to the input image to generate an output image, and displaying the output image via a display device of the type of display device.

According to certain embodiments, a computer-implemented method may include determining a power profile associated with display content being designed, the power profile indicating a quantitative or qualitative power consumption for displaying the display content on a type of display device; displaying, via a user interface, the power profile associated with the display content; identifying a modification to the display content to reduce power consumption for displaying the display content on the type of display device; and providing, via the user interface, a recommendation to make the modification to the display content.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an image source assembly in an augmented reality system according to certain embodiments.

FIG. 5A illustrates an example of a power consumption model of a liquid crystal (LC) panel (excluding the backlight unit).

FIG. 5B illustrates an example of a power consumption model of a backlight unit of a LC display.

FIG. 6A illustrates an example of an original input image to be edited to reduce display power.

FIGS. 6B-6G illustrate examples of techniques for saving display power by modifying image brightness of the original input image.

FIG. 6H illustrates the perceptual impact and power saving of the techniques used in FIGS. 6B-6G.

FIG. 7 illustrates examples of transfer functions of perceptual impact versus power saving for OLED displays using various power saving techniques.

FIG. 8 includes a table illustrating examples of power saving using various power saving techniques for OLED displays with perceptual impact of one just-objectionable-difference (JOD).

FIG. 9 illustrates examples of transfer functions of perceptual impact versus power saving for global dimming LC displays using various power saving techniques.

FIG. 10 includes a table illustrating examples of power saving using various power saving techniques for global dimming LC displays with perceptual impact of one JOD.

FIG. 11 illustrates examples of transfer functions of perceptual impact versus power saving for local dimming LC displays using various power saving techniques.

FIG. 12 includes a table illustrating examples of power saving using various power saving techniques for local dimming LC displays with perceptual impact of one JOD.

FIG. 13 illustrates examples of color difference and power saving for displaying a set of images using different primaries.

FIG. 14A illustrates examples of power savings in OLED displays using gaze-contingent power saving techniques.

FIG. 14B illustrates examples of power savings in local dimming LC displays using gaze-contingent power saving techniques.

FIG. 15 illustrates an example of using perceptual impact-aware machine learning techniques to edit images to reduce display power according to certain embodiments.

FIG. 16A illustrates examples of input images to a deep neural network for editing images to reduce display power.

FIG. 16B illustrates examples of output images generated by the deep neural network that minimizes visible distortion between input and output images, while maximizing the predicted display power saving, according to certain embodiments.

FIG. 17 illustrates examples of results of the combined perceptual and power analysis of output images generated from the input images by the deep neural network according to certain embodiments.

FIGS. 18A and 18B illustrate examples of implementations of a design tool that provides display power scores and/or recommendations to content creators during display content design according to certain embodiments.

FIG. 19 includes a flowchart illustrating an example of a process of editing an image to reducing the power consumption for displaying the image while maintaining a visual fidelity of the edited display content.

FIG. 20 is a simplified block diagram of an electronic system of an example of a near-eye display according to certain embodiments.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to head-mounted displays (HMDs) or other near-eye displays (NEDs). More specifically, and without limitation, techniques disclosed herein relate to models (e.g., machine learning models or traditional models) and design tools for designing display content to save power while maintaining good visual fidelity in head-mounted display, based on combined or unified display content perceptual and power analysis techniques. Various inventive embodiments are described herein, including systems, methods, processes, algorithms, applications, program code, machine learning models, neural networks, design tools, user interfaces, and the like.

Augmented reality (AR), virtual reality (VR), mixed reality (MR), and other artificial reality applications may use head-mounted displays (HMDs) that include display panels that are near user's eyes. The display panels may include, for example, a liquid crystal display (LCD), an organic light emitting diode (OLED) display, a micro-OLED display, a liquid crystal on silicon (LCOS) display, an inorganic light emitting diode (ILED) display, a micro light emitting diode (micro-LED) display, an active-matrix OLED display (AMOLED), a transparent OLED display (TOLED), a laser-based display device, a digital light processing (DLP) display device, or some other displays. The display panels may include light emitters and drive circuits that provide drive currents to the light emitters to cause light emission by the light emitters. The display panels may have high power consumption in order to provide bright, high-resolution, and high-refresh rate images. However, as wearable devices, head-mounted displays may be constrained in the amount of power that can be used by the display device. The power constrain in HMDs may be even more strict than that of other standalone devices (such as cell phones), because HMDs are generally worn on users' heads, and thus the weight constraints may be much more restrictive.

The display of an HMD may often consume a large portion of the total power consumption of the HMD, where the remaining portions may be used by, for example, data processing. Therefore, saving a significant portion of the power used by the display can greatly reduce the total power consumption of the HMD, and/or may free up battery budget for other tasks such as data processing, such that the HMDs may be lighter and more efficient, and can have longer battery life between battery charging or replacement. The amount of power consumption of a display may depend on several factors, such as the maximum brightness in the image (which may be important for LC displays), mean brightness or colors (which may be important for local dimming or LED displays), and the like. Various techniques may be used to reduce the display power, such as dimming the display, manipulating the content being displayed, and the like. However, these techniques may change the quality of the displayed image or video and thus may affect the user perception and user experience. For example, these techniques may cause visible distortions in terms of contrast, color accuracy, and/or brightness. Therefore, it may be difficult to achieve both high image quality and high display power efficiency. A compromise may need to be made to balance the quality of the displayed images and the power saving of the display when using the power saving techniques.

In addition, the power consumption for displaying the same content may vary significantly depending on the architecture of the display. As such, some power-saving techniques that may be suitable for one type of display may not be suitable for another type of display. For example, for emissive displays where individual pixels produce their own light, such as organic light-emitting diode (OLED), each pixel's power profile may be proportional to its intensity. In contrast, transmissive displays may use a separate light source, such as a back-light unit (BLU), to illuminate a subtractive filter array, and thus the power consumption may be dominated by the BLU intensity and may have little to no dependence on individual pixel values. However, currently, there is no comprehensive, quantitative modeling of how the power savings provided by these techniques may impact the visual quality in each type of display of different types of displays.

Certain embodiments disclosed herein relate to techniques for improving display power saving while maintaining good visual fidelity in head-mounted displays. In some embodiments, a unified display power and perceptual impact analysis technique is used to quantify the performance of a power saving technique, including both the perception (e.g., video difference metrics) and power saving, using transfer functions or other figures of merit. The technique may be automated to evaluate the display power and perceptual performance for a large set of power saving techniques, parameters of the techniques, display types, image types, and the like. For example, for each display technology (e.g., LCD, LCOS, micro-LED, OLED, micro-OLED, etc.), a model (e.g., a transfer function) may be generated and used to predict how much power a display may consume or save for displaying a certain image or video using a power-saving technique, and how much the power saving technique may impact the user perception. The power saving techniques (also referred to herein as display mapping techniques) may include, for example, uniform dimming, luminance clipping, brightness rolloff, dichoptic dimming, whitepoint shifting, color foveation, and the like.

According to certain embodiments, automated techniques for evaluating the display power and perceptual performance may be used to train machine learning models for display mapping, where the machine learning models (e.g., deep neural networks or filters with weights/coefficients) may be trained to minimize a visual difference between input and output images while maximizing a predicted display power saving. For example, the automated techniques may be used to quantify the power saving and perceptual impact of the image generated by the model being trained, so that the model may be tuned to generate images with higher power saving and lower perceptual impact. The trained machine learning models may then be used to automatically generate images that can save display power while maintaining good visual fidelity to the original image. For example, the trained model may be a filter having the same size/resolution as the input images (e.g., the size of a target display), where the coefficients or weights of the filter may be learnt through the training process, such that an image that can save display power while maintaining good visual fidelity to the original image may be generated by applying the filter to the original image (e.g., through matrix multiplication).

According to certain embodiments, a design tool (e.g., computer-aided design (CAD) software) may be provided to content creators to enable power saving-aware designs during the content creation process. An interface of the design tool may be used to inform content creators of the power profiles of the display content being created and guide the content creators to achieve more power-efficient designs when possible. For example, the design tool may evaluate a power profile associated with the display content being designed in terms of power usage (e.g., by scoring it on a scale of 0-100 or as bad or good), and may notify a user regarding design content that may have low power profile scores, and provide suggestions for improving the power profile (e.g., by swapping a color palette) to the user. In some embodiments, the design tool may also estimate how long an application can run on a device according to a selected user interface (UI) design (e.g., 40 minutes for a first UI design, 55 minutes for a second UI design, etc.) and present the estimated run time to the user. In some embodiments, the design tool may calculate an image difference metric of a new design with respect to an original design.

Techniques described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through). In some AR systems, the artificial images may be presented to users using an LED-based display subsystem.

As used herein, just-objectionable-difference (JOD) is a unit for measuring impairment or pairwise comparison. A JOD value may indicate the probability of selecting one option A over the other option B of two options by observers. See, e.g., Maria Perez-Ortiz et al., “From pairwise comparisons and rating to a unified quality scale,” IEEE Transactions on Image Processing 29 (2019), 1139-1151. When the number of observers selecting option A and the number of observers selecting option B are equal, the probability is 0.5, and the JOD between the two options is 0. The differences of 1 JOD, 2 JODs, and 3 JODs correspond to probabilities P (A>B) of 0.75, 0.91, and 0.97, respectively. For example, one JOD may indicate that option A is selected over option B 75% of the time (or by 75% of the observers). A positive JOD value indicates that more observers prefer option A over option B, while a negative JOD value indicates that more observers prefer option B over option A. In this description, the JOD value of a reference image may be 0, and thus JOD values of images modified for power saving may generally be negative because the modified version of the reference image may generally have a lower perceptual quality than the reference image.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

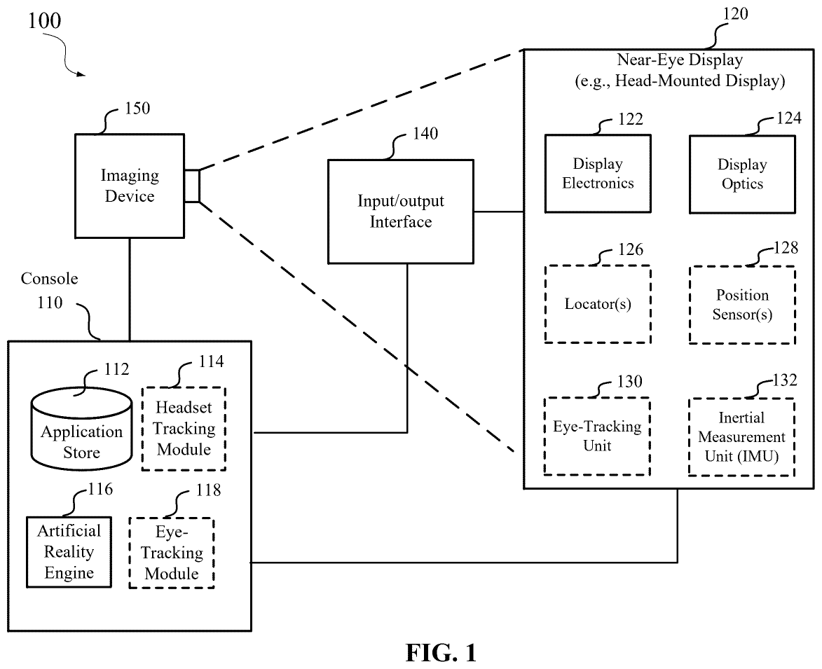

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

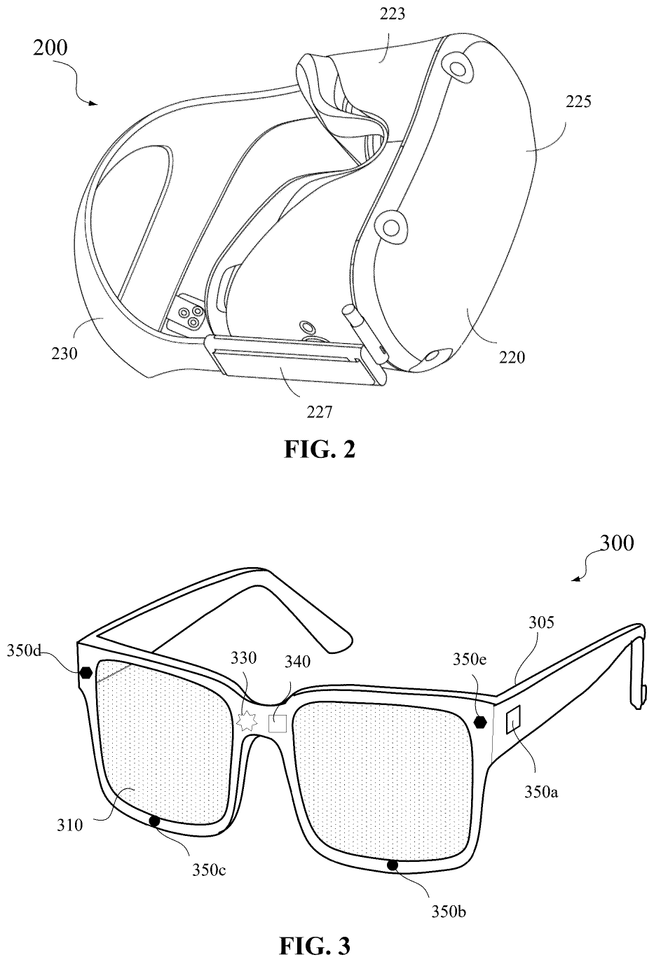

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to function as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), a laser-based display device, a DLP display device, or some other displays. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices).

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120.

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. Artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to determine the eye's orientation more accurately.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, a laser display device, a DLP display device, some other displays, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

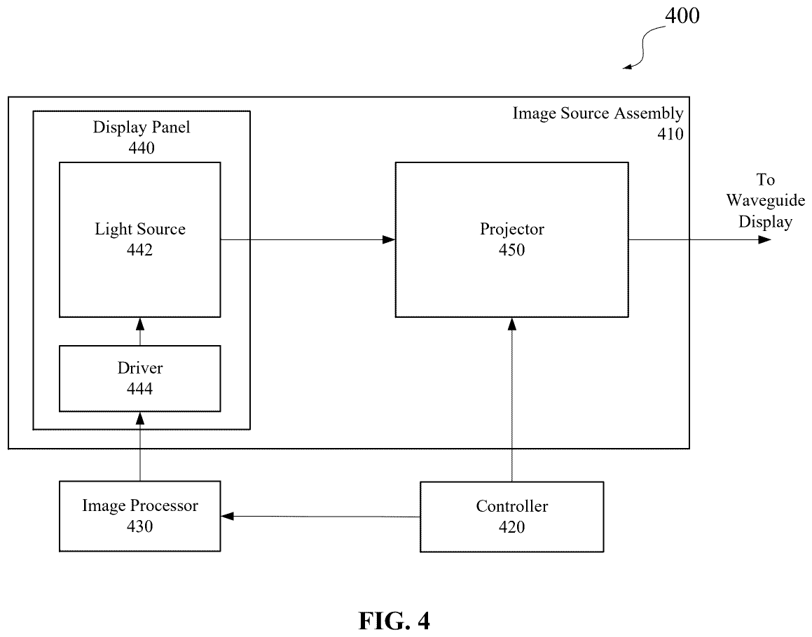

FIG. 4 illustrates an example of an image source assembly 410 in a near-eye display system 400 according to certain embodiments. Image source assembly 410 may include, for example, a display panel 440 that may generate display images to be projected to the user's eyes, and a projector 450 that may project the display images generated by display panel 440 to a waveguide display as described above. Display panel 440 may include a light source 442 and a drive circuit 444 for light source 442. Near-eye display system 400 may also include a controller 420 that synchronously controls light source 442 and projector 450 (e.g., scanning mirror 570). Image source assembly 410 may generate and output an image light to a waveguide display (not shown in FIG. 4). As described above, the waveguide display may receive the image light at one or more input-coupling elements, and guide the received image light to one or more output-coupling elements. The input and output coupling elements may include, for example, a diffraction grating, a holographic grating, a prism, or any combination thereof. The input-coupling element may be chosen such that total internal reflection occurs with the waveguide display. The output-coupling element may couple portions of the total internally reflected image light out of the waveguide display.

As described above, light source 442 may include a plurality of light emitters arranged in an array or a matrix. Each light emitter may emit monochromatic light, such as red light, blue light, green light, infra-red light, and the like. While RGB colors are often discussed in this disclosure, embodiments described herein are not limited to using red, green, and blue as primary colors. Other colors can also be used as the primary colors of near-eye display system 400. In some embodiments, a display panel in accordance with an embodiment may use more than three primary colors. Each pixel in light source 442 may include three subpixels that include a red micro-LED, a green micro-LED, and a blue micro-LED. A semiconductor LED generally includes an active light emitting layer within multiple layers of semiconductor materials. The multiple layers of semiconductor materials may include different compound materials or a same base material with different dopants and/or different doping densities. For example, the multiple layers of semiconductor materials may include an n-type material layer, an active region that may include hetero-structures (e.g., one or more quantum wells), and a p-type material layer. The multiple layers of semiconductor materials may be grown on a surface of a substrate having a certain orientation.

Controller 420 may control the image rendering operations of image source assembly 410, such as the operations of light source 442 and/or projector 450. For example, controller 420 may determine instructions for image source assembly 410 to render one or more display images. The instructions may include display instructions and scanning instructions. In some embodiments, the display instructions may include an image file (e.g., a bitmap file). The display instructions may be received from, for example, a console, such as console 110 described above with respect to FIG. 1. The scanning instructions may be used by image source assembly 410 to generate image light. The scanning instructions may specify, for example, a type of a source of image light (e.g., monochromatic or polychromatic), a scanning rate, an orientation of a scanning apparatus, one or more illumination parameters, or any combination thereof. Controller 420 may include a combination of hardware, software, and/or firmware not shown here so as not to obscure other aspects of the present disclosure.

In some embodiments, controller 420 may be a graphics processing unit (GPU) of a display device. In other embodiments, controller 420 may be other kinds of processors. The operations performed by controller 420 may include taking content for display and dividing the content into discrete sections. Controller 420 may provide to light source 442 scanning instructions that include an address corresponding to an individual source element of light source 442 and/or an electrical bias applied to the individual source element. Controller 420 may instruct light source 442 to sequentially present the discrete sections using light emitters corresponding to one or more rows of pixels in an image ultimately displayed to the user. Controller 420 may also instruct projector 450 to perform different adjustments of the light. For example, controller 420 may control projector 450 to scan the discrete sections to different areas of a coupling element of the waveguide display. As such, at the exit pupil of the waveguide display, each discrete portion is presented in a different respective location. While each discrete section is presented at a different respective time, the presentation and scanning of the discrete sections occur fast enough such that a user's eye may integrate the different sections into a single image or series of images.

Image processor 430 may be a general-purpose processor and/or one or more application-specific circuits that are dedicated to performing the features described herein. In one embodiment, a general-purpose processor may be coupled to a memory to execute software instructions that cause the processor to perform certain processes described herein. In another embodiment, image processor 430 may be one or more circuits that are dedicated to performing certain features. While image processor 430 in FIG. 4 is shown as a stand-alone unit that is separate from controller 420 and drive circuit 444, image processor 430 may be a sub-unit of controller 420 or drive circuit 444 in other embodiments. In other words, in those embodiments, controller 420 or drive circuit 444 may perform various image processing functions of image processor 430. Image processor 430 may also be referred to as an image processing circuit.

In the example shown in FIG. 4, light source 442 may be driven by drive circuit 444, based on data or instructions (e.g., display and scanning instructions) sent from controller 420 or image processor 430. In one embodiment, drive circuit 444 may include a circuit panel that connects to and mechanically holds various light emitters of light source 442. Light source 442 may emit light in accordance with one or more illumination parameters that are set by the controller 420 and potentially adjusted by image processor 430 and drive circuit 444. An illumination parameter may be used by light source 442 to generate light. An illumination parameter may include, for example, source wavelength, pulse rate, pulse amplitude, beam type (continuous or pulsed), other parameter(s) that may affect the emitted light, or any combination thereof. In some embodiments, the source light generated by light source 442 may include multiple beams of red light, green light, and blue light, or any combination thereof.

Projector 450 may perform a set of optical functions, such as focusing, combining, conditioning, or scanning the image light generated by light source 442. In some embodiments, projector 450 may include a combining assembly, a light conditioning assembly, or a scanning mirror assembly. Projector 450 may include one or more optical components that optically adjust and potentially re-direct the light from light source 442. One example of the adjustment of light may include conditioning the light, such as expanding, collimating, correcting for one or more optical errors (e.g., field curvature, chromatic aberration, etc.), some other adjustments of the light, or any combination thereof. The optical components of projector 450 may include, for example, lenses, mirrors, apertures, gratings, or any combination thereof.

Projector 450 may redirect image light via its one or more reflective and/or refractive portions so that the image light is projected at certain orientations toward the waveguide display. The location where the image light is redirected toward the waveguide display may depend on specific orientations of the one or more reflective and/or refractive portions. In some embodiments, projector 450 includes a single scanning mirror that scans in at least two dimensions. In other embodiments, projector 450 may include a plurality of scanning mirrors that each scan in directions orthogonal to each other. Projector 450 may perform a raster scan (horizontally or vertically), a bi-resonant scan, or any combination thereof. In some embodiments, projector 450 may perform a controlled vibration along the horizontal and/or vertical directions with a specific frequency of oscillation to scan along two dimensions and generate a two-dimensional projected image of the media presented to user's eyes. In other embodiments, projector 450 may include a lens or prism that may serve similar or the same function as one or more scanning mirrors. In some embodiments, image source assembly 410 may not include a projector, where the light emitted by light source 442 may be directly incident on the waveguide display.

Head-mounted displays or other near-eye displays such as the ones described above include light emitters and drive circuits that provide drive currents to the light emitters to cause light emission by the light emitters. The display panels may have high power consumption in order to provide bright, high-resolution, and high-refresh rate images. However, as wearable device, head-mounted displays may be constrained in the amount of power that can be used by the display device. The power constrain in HMDs may be even more strict than that of other standalone devices (such as cell phones), because HMDs are generally worn on users' heads and thus the weight constraints may be much more restrictive.

The display of an HMD may often consume a large portion of the total power consumption of the HMD, where the remaining portions may be used by, for example, data processing. Therefore, saving a significant portion of the power used by the display can greatly reduce the total power consumption of the HMD, and/or may free up battery budget for other tasks such as data processing, such that the HMDs may be lighter and more efficient, and can have longer battery life between battery charging or replacement. The amount of power consumption of a display may depend on several factors, such as the maximum brightness in the image (which may be important for LC displays), mean brightness or colors (which may be important for local dimming or LED displays), and the like. Various techniques may be used to reduce the display power, such as dimming the display, manipulating the content being displayed, and the like. However, these techniques may change the quality of the displayed image or video and thus may affect the user perception and user experience. For example, these techniques may cause visible distortions in terms of contrast, color accuracy, and/or brightness. Therefore, it may be difficult to achieve both high image quality and high display power efficiency. A compromise may need to be made to balance the quality of the displayed images and the power saving of the display when using the power saving techniques. In addition, the power consumption for displaying the same content may vary significantly depending on the architecture of the display. As such, some power-saving techniques that may be suitable for one type of display may not be suitable for another type of display. Unified, comprehensive quantitative modeling of how the power savings provided by these techniques may impact the visual quality in each type of display of different types of displays may be desired.

Certain embodiments disclosed herein relate to techniques for improving display power saving while maintaining good visual fidelity in head-mounted displays. In some embodiments, a unified display power and perceptual impact analysis technique is used to quantify the performance of a power saving technique, including both the perception (e.g., video difference metrics) and power saving, using transfer functions or other figures of merit. The technique may be automated to evaluate the display power and perceptual performance for a large set of power saving techniques, parameters of the techniques, display types, image types, and the like. For example, for each display technology (e.g., LCD, LCOS, micro-LED, OLED, micro-OLED, etc.), a model (e.g., a transfer function) may be generated and used to predict how much power a display may consume or save for displaying a certain image or video using a power-saving technique, and how much the power saving technique may impact the user perception. The power saving techniques (also referred to herein as display mapping techniques) may include, for example, uniform dimming, luminance clipping, brightness rolloff, dichoptic dimming, whitepoint shifting, color foveation, and the like.

Display power consumption may depend on the image content being displayed. For example, for emissive displays where individual pixels produce their own light, such as OLED displays, the total power consumption of the display may be the sum of the power consumption of each pixel, which may be proportional to the intensity or pixel value of the pixel. For transmissive displays (e.g., LC displays) that may use a separate light source (e.g., BLU) to illuminate a subtractive filter array, the power consumption model can be very different. For example, the power consumption may be dominated by the BLU intensity and may have little to no dependence on individual pixel values. The design of optimal power-saving methods for each display type requires accurate measurement and characterization of how a display's power consumption varies with pixel intensity distribution.

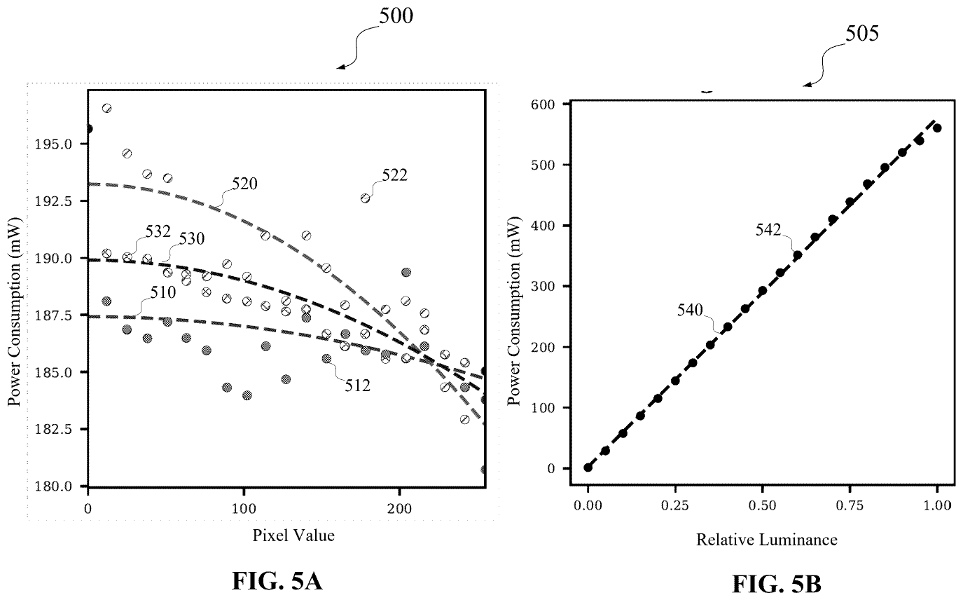

FIG. 5A includes a diagram 500 illustrating an example of a power consumption model of a liquid crystal (LC) panel (excluding the backlight unit). In FIG. 5A, the horizontal axis corresponds to pixel values, whereas the vertical axis corresponds to power consumption (in mW). Data points 512, 522, and 532 represent measured power consumption values for red pixels, green pixels, and blues pixels, respectively, at different pixel values. The power consumption of LC panel can be described as a per-channel summation of second-order polynomial functions of pixel value:

$${M}_{LC} ( c ) = {\sum }_{p = 1}^{3} {α}_{p} {c}_{p}^{2} + {δ}_{p} ,$$

where αₚ, δₚ are model parameters that can be determined by regression model fitting based on the measured data point, p is the index of an RGB primary, and c is a linear RGB pixel color value. Curves 510, 520, and 530 are power consumption models generated by fitting the models described above to the measured data points for red pixels, green pixels, and blues pixels, respectively.

FIG. 5B includes a diagram 505 illustrating an example of a power consumption model of a backlight unit of a LC display. In FIG. 5B, the horizontal axis corresponds to relative luminance of the light sources (e.g., LEDs) in the BLU, while the vertical axis corresponds to power consumption of the BLU of the display. Data points 542 represent measured power consumption of the BLU of the display at different relative LED luminance levels. Data points 542 show that the power consumption of the BLU may have a strong positive relation with the relative luminance of the LEDs and can be modeled as a linear function of relative LED luminance γ:

$${M}_{B} ( y ) = α y + δ ,$$

where α and β are parameter can be determined by fitting the linear model to measured data. A line 940 illustrates the model of the power consumption of the BLU generated by fitting the linear model to measured data points through linear regression.

The total power consumption of an LC display can be modeled as a sum of the power consumption by the BLU and power consumption of the LC panel. FIGS. 5A and 5B show that the variation in the power consumption of the BLU (e.g., >570 mW) is more than an order of magnitude higher than the variation of the power consumption of the LC panel (e.g., <20 mW). Therefore, the contribution of the LC panel to the total power consumption of the LC display may be negligible.

The spatial resolution of the BLU is generally much lower than the displayed image. The BLU LEDs can have different intensities depending on the image processing algorithm employed. For instance, in an LC display with a global dimming backlight, all BLU LEDs may have the same driving value, which may be set to the maximum pixel intensity of the displayed image. The power consumption in the global dimming setting is therefore a function of the maximum pixel intensity. In an LC display with local dimming setting, BLU LEDs may be modulated individually, where the power consumption of each LED may be modeled as a function of the LED driving value, which may be determined using, for example, a heuristic optimization procedure. More accurate computation of the driving values may consider the spatial location of BLU LEDs and the optical blur due to diffusers as well as other physical components of the LC display, where the light spread, such as a point spread function (PSF), of an individual illuminated LED may be determined.

As described above, display mapping techniques for modifying the images to be displayed to reduce power consumption may include, for example, uniform dimming, luminance clipping, brightness rolloff, dichoptic dimming, whitepoint shifting, color foveation, and the like. Different display mapping techniques may have different impact on user perception and power saving. Each display mapping technique may have different performance for different types of display. For example, one of the most common display mapping techniques for mobile devices may be uniform dimming, which may scale down the display brightness linearly. Luminance clipping may be used to clip the luminance in high-luminance regions while preserving the brightness in most regions of the image at the expense of detail and brightness in highlight regions. In self-emissive LED-based displays, color remapping can save power by shifting pixel colors based on differences in the luminous efficiency of LEDs of different primary colors. Wide field displays may take advantages of the limited perceptual acuity of the human visual system through eye-tracked methods such as peripheral dimming or foveated color remapping.

Uniform dimming may be used in low-battery modes for smart phones and other mobile display technologies, such as windows adaptive brightness control. In uniform dimming, all image pixel values may be linearly scales down according to:

$${c}^{′} = ( 1 - α ) c .$$

Luminance clipping technique may clip the highest-luminance image features, such that luminance values over a certain threshold value may be replaced with the threshold value, while luminance values below the threshold value may not be scaled down or may be scaled down by a small ratio or value, so that details of the features with low luminance values may be preserved, but some details in the high luminance regions may be lost.

Brightness rolloff technique may be an eye-tracked method that applies peripheral dimming using a Gaussian profile:

$${c}^{′} = exp ( \frac{4 ln ( 1 - α )}{{( FOV - θ )}^{2}} {ϕ}^{2} ) c ,$$

where FOV is the maximum field of view of the display. The retinal eccentricity of a pixel located at image coordinates (x, y) is computed as

$$ϕ = \frac{1}{ppd} \sqrt{{( x - {g}_{x} )}^{2} + {( y - {g}_{y} )}^{2}} ,$$

where g is the image-space gaze location and ppd is peak pixel density of the display. The foveal region (e.g., within θ=10 eccentricity) is unmodified. In some example, linear rolloff, rather than Gaussian rolloff, may be used.

Dichoptic dimming techniques may use different rendering modalities for each eye in a binocular display. Rather than dimming the display equally for both eyes as in uniform dimming, the display for one eye may be dimmed. Because a majority (e.g., about 70%) of the population is right-eye dominant, the display for the left eye may be dimmed.

Human color perceptual acuity is highest in the fovea, and decreases with retinal eccentricity. Color foveation techniques utilize this characteristic in displays with non-uniform color efficiencies, such as OLED displays, by modulating pixel chromaticity in a power-aware fashion:

$${c}^{′} = c + α ( f ( c , ϕ ) - c ) ,$$

where function ƒ may model the power-optimal color shift of c located at eccentricity ϕ and may compute the power-minimal color within a set of colors.

Similar to color remapping techniques discussed above, the whitepoint shifting technique may leverage the chromatic adaptation of human eyes to shift the display whitepoint to a more power-optimal whitepoint. Based on the source whitepoint and shifted whitepoint, a chromatic adaptation matrix may be computed by following a linear simplification of the Bradford chromatic adaptation transform.

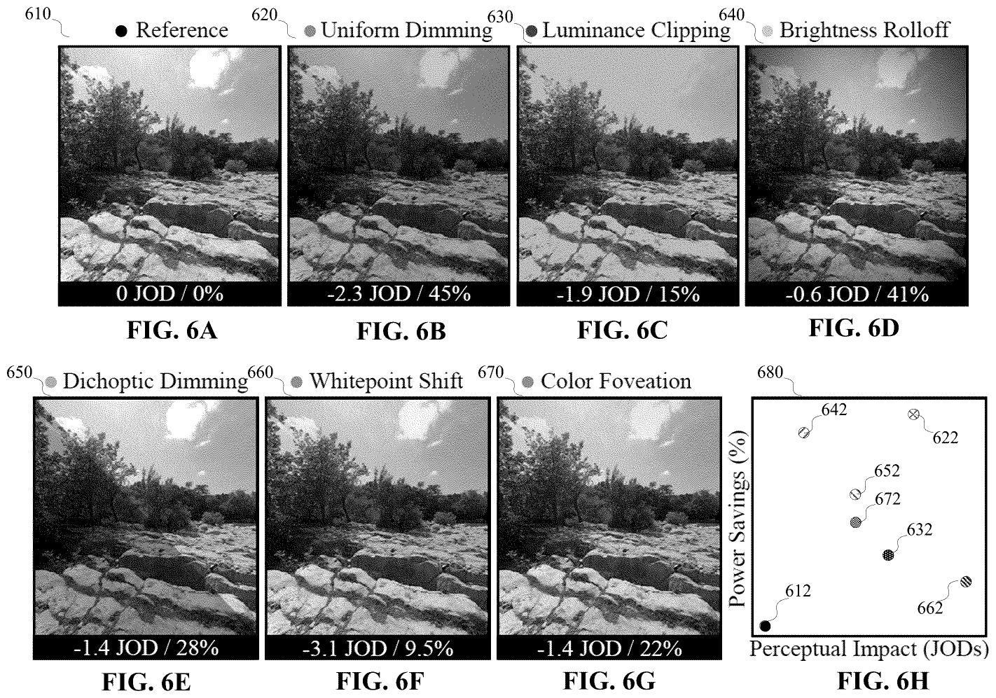

FIG. 6 illustrates an example of an original input image 610 to be edited to reduce display power. FIGS. 6B-6G illustrate examples of techniques for saving display power by manipulating image brightness of the original input image. For example, FIG. 6B illustrates an example of an image 620 generated by applying uniform dimming on input image 610 shown in FIG. 6A, where, compared with displaying image 610, the power consumption for displaying image 620 may be reduced by about 45% but the perceived image quality may degrade by about 2.3 JODs. FIG. 6C illustrates an example of an image 630 generated by clipping maximum luminance regions of input image 610 shown in FIG. 6A using the luminance clipping technique, where, compared with displaying image 610, the power consumption for displaying image 630 may be reduced by about 15% and the perceived image quality may degrade by about 1.9 JODs. FIG. 6D illustrates an example of an image 640 generated by applying the brightness rolloff technique to input image 610 (e.g., using a foveated luminance rolloff technique based on the user's gaze location/direction), where, compared with displaying image 610, the power consumption for displaying image 640 may be reduced by about 41% and the perceived image quality may degrade only by about 0.6 JODs. FIG. 6E illustrates an example of an image 650 generated by applying the dichoptic dimming technique to input image 610, where, compared with displaying image 610, the power consumption for displaying image 650 may be reduced by about 28% and the perceived image quality may degrade only by about 1.4 JODs. FIG. 6F illustrates an example of an image 660 generated by applying the whitepoint shift technique to input image 610, where, compared with displaying image 610, the power consumption for displaying image 640 may be reduced by about 9.5% and the perceived image quality may degrade by about 3.1 JODs. FIG. 6G illustrates an example of an image 670 generated by applying the color foveation technique described above to input image 610, where, compared with displaying image 610, the power consumption for displaying image 670 may be reduced by about 22% and the perceived image quality may degrade by about 1.4 JODs. These techniques may reduce the power consumption of the display by different amounts, and may change the quality or user perception of the displayed image or video by different amounts as well. Some of these techniques may have higher power saving and lower perceptual impact on the image quality.

FIG. 6H includes a diagram 680 showing the perceptual impact and power saving of the techniques used in FIGS. 6B-6G. The horizontal axis corresponds to perceptual impact (in units of JOD), whereas the vertical axis corresponds to power saving (in percentage). A data point 612 shows the power saving (e.g., 0%) and perceptual impact (e.g., 0 JODs) of using original input image 610. A data point 622 shows the power saving (e.g., about 45%) and perceptual impact (e.g., about −2.3 JODs) of using image 620 generated using the uniform dimming technique. A data point 632 shows the power saving (e.g., about 15%) and perceptual impact (e.g., about −1.9 JODs) of using image 630 generated using the luminance clipping technique. A data point 642 shows the power saving (e.g., about 41%) and perceptual impact (e.g., about −0.6 JODs) of using image 640 generated using the brightness rolloff technique. A data point 652 shows the power saving (e.g., about 28%) and perceptual impact (e.g., about −1.4 JODs) of using image 650 generated using the dichoptic dimming technique. A data point 662 shows the power saving (e.g., about 9.5%) and perceptual impact (e.g., about −3.1 JODs) of using image 660 generated using the whitepoint shift technique. A data point 672 shows the power saving (e.g., about 22%) and perceptual impact (e.g., about −1.4 JODs) of using image 670 generated using the color foveation technique. Data points close to the top left corner may represent display mapping techniques that can have higher power saving and lower perceptual impact and thus may be used. For example, in FIG. 6H, data point 642 corresponding to the brightness rolloff technique may be close to the top left corner (having high power saving and lower perceptual impact), while data point 662 representing the whitepoint shift technique may be at the bottom right corner (having a lower power saving and higher perceptual impact).

Most perception-based techniques (such as those described with respect to FIGS. 6B-6G) are generally evaluated in isolation. For example, it is common for engineers to conduct a subjective evaluation of a single technique. This may make it difficult to compare different techniques to each other, as they generally are not evaluated together in similar circumstances, on similar content types, and the like.

Certain embodiments disclosed herein relate to techniques for improving display power saving while maintaining good visual fidelity in head-mounted displays. In some embodiments, a unified display power and perceptual impact analysis technique is used to quantify the performance of a power saving technique, including both the perception (e.g., video difference metrics) and power saving, for example, using certain transfer functions or figures of merit. For example, a unified two-interval forced choice (2-IFC)-based subjective study technique may be used to produce comprehensive evaluations of any visual technique and compare it against all other candidate techniques. The 2-IFC procedure may be used in a wide range of applications in vision, audition, cognition and other fields. In a 2-IFC task, a single experimental trial includes two temporal intervals. The signal may be presented in one of the two temporal intervals, and the observer is required to report the interval (e.g., first vs. second) in which the signal was presented. In some embodiments, other image difference metrics, instead of or in addition to the 2-IFC-based subjective user study technique, may be used to evaluate the differences between the original image and images edited by the image editing techniques as they are displayed by a type of display device. The power profiles of each image editing technique for a set of images may also be determined and compared, and may be used together with the results of the 2-IFC-based subjective study or other image difference metrics to provide a direct perception to power evaluation for a given display technology, for example, using transfer functions.

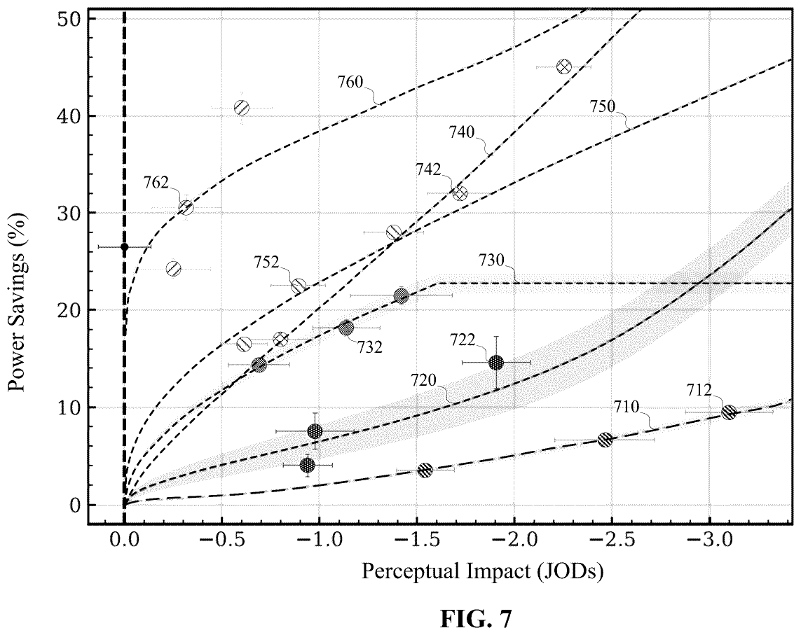

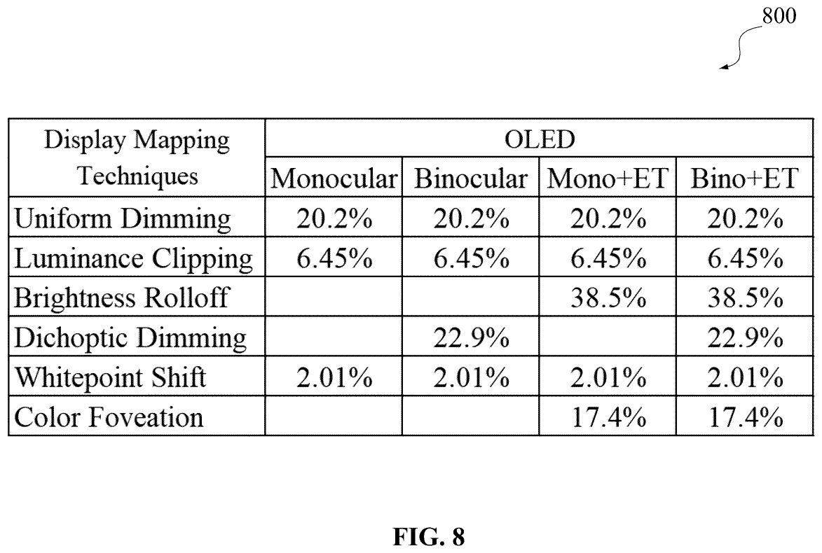

In one example, a series of perceptual studies with natural stimuli and free-form viewing were conducted to measure the subjective quality of different power-saving techniques discussed above. The experimental procedure includes a two-interval forced choice task (2-IFC) using the method of paired comparisons, which has been shown to result in less noisy data compared to direct rating studies. At the start of each trial, users are shown the reference video, and can freely switch between the reference video and two test videos using a 3-button keyboard, with final selections made using a foot pedal. A grey blank screen was displayed for 500 ms when stimuli were switched, and was introduced to aid with adaptation so that participants would not make direct comparisons between stimuli by “flipping” between conditions. Users were allowed to make natural eye and head movements to simulate behavior representative of natural VR/AR use. Each participant performed the experiment on one of multiple display types (e.g., OLED displays and LC displays). Participants were instructed to select the video with higher quality or fewer distortions, and were required to view both test videos at least once before proceeding. The pairwise comparison data from the study was scaled to units of JODs using Bayesian maximum likelihood estimation under Thurstone's Case V model as implemented using the Bayesian pairwise comparison scaling (pwcmp) software. See, e.g., Maria Perez-Ortiz et al., “From pairwise comparisons and rating to a unified quality scale,” IEEE Transactions on Image Processing 29 (2019), 1139-1151. Scaling the data to JODs allows the comparison of methods based on the same perceptual scale, and enables an easy conversion to interpretable units of percentage preference. For example, as described above, a method A scored one JOD greater than method B may indicate that method A was selected 75% of the time over method B. Results of the studies are shown in FIGS. 7-12 below. The JOD error bars are computed by simulating 2,000 bootstrap samples using the procedure described by Perez-Ortiz. The JOD values are relative to the reference (set to 0). Scores for each display mapping technique represent distance from the reference. The data points for each display mapping technique are fitted to generate a transfer function of perceptual impact versus power saving. The transfer functions in FIGS. 7, 9, and 11 were evaluated for each method at −1 JOD for common XR display types, including non-eye-tracked (ET) as well as eye-tracked monocular and binocular displays, and the results are shown in FIGS. 8, 10, and 12.

FIG. 7 illustrates examples of transfer functions of perceptual impact versus power saving for OLED displays using various power saving techniques. In FIG. 7, the horizontal axis corresponds to the perceptual impact in units of JOD, while the vertical axis corresponds to the power saving (in %). Data points 712, 722, 732, 742, 752, and 762 represent power savings for different perceptual impacts using the whitepoint shift technique, luminance clipping technique, color foveation technique, uniform dimming technique, dichoptic dimming technique, and brightness rolloff technique, respectively. Horizontal and vertical error bars represent 95% confidence intervals of JOD scores and power savings, respectively. Power savings for techniques such as uniform dimming and dichoptic dimming are content-independent and thus do not exhibit any vertical error bars. Curves 710, 720, 730, 740, 750, and 760 are transfer functions of power saving versus perceptual impact for the whitepoint shift technique, luminance clipping technique, color foveation technique, uniform dimming technique, dichoptic dimming technique, and brightness rolloff technique, respectively. Shaded regions in FIG. 7 represent 95% confidence intervals of power savings.

FIG. 8 includes a table 800 illustrating examples of power saving using various power saving techniques for OLED displays with perceptual impact of one JOD. As shown in table 800, the power savings for uniform dimming, luminance clipping, and whitepoint shift may not depend on whether the display is a monocular or binocular display and whether eye-tracking is used. The brightness rolloff and color foveation techniques may not be applicable to displays without eye-tracking. The dichoptic dimming technique may not be applicable to monocular displays. Table 800 shows that the brightness rolloff technique may provide the highest power saving at a loss of one JOD for OLED displays.

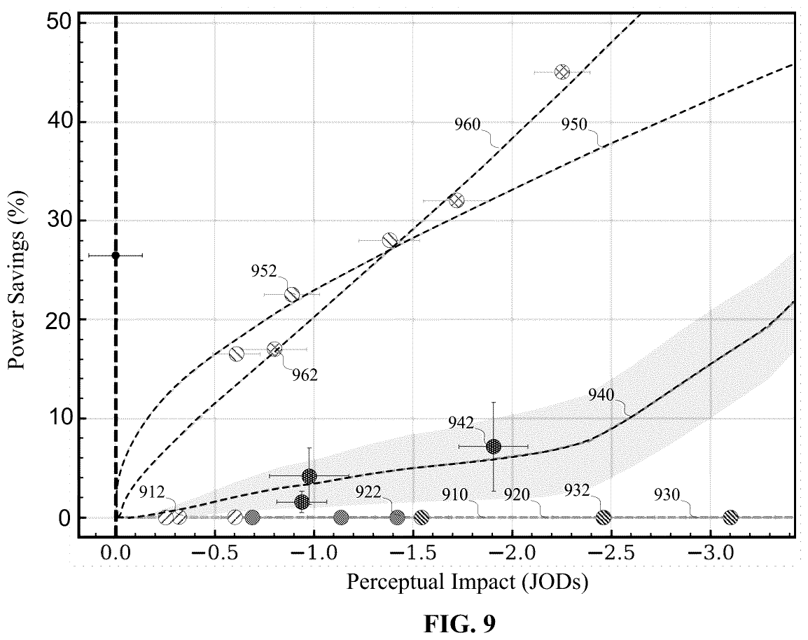

FIG. 9 illustrates examples of transfer functions of perceptual impact versus power saving for global dimming LC displays using various power saving techniques. In FIG. 9, the horizontal axis corresponds to the perceptual impact in units of JOD, while the vertical axis corresponds to the power saving (in %). Data points 912, 922, 932, 942, 952, and 962 represent power savings for different perceptual impacts using the brightness rolloff technique, color foveation technique, whitepoint shift technique, luminance clipping technique, dichoptic dimming technique, and uniform dimming technique, respectively. Horizontal and vertical error bars represent 95% confidence intervals of JOD scores and power savings, respectively. Power savings for techniques such as uniform dimming and dichoptic dimming are content-independent and thus do not exhibit any vertical error bars. Curves 910, 920, 930, 940, 950, and 960 are transfer functions of power saving versus perceptual impact for the brightness rolloff technique, color foveation technique, whitepoint shift technique, luminance clipping technique, dichoptic dimming technique, and uniform dimming technique, respectively. Shaded regions in FIG. 9 represent 95% confidence intervals of power savings.

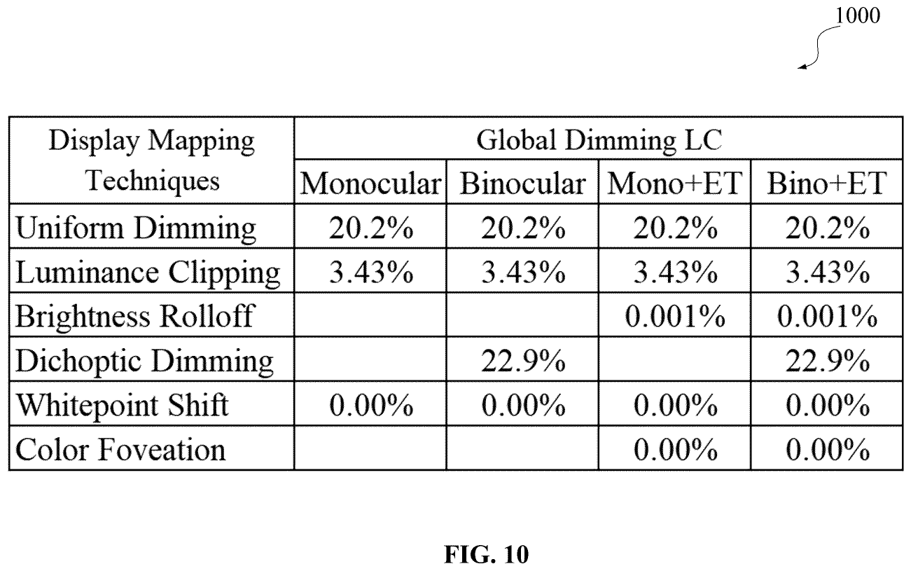

FIG. 10 includes a table 1000 illustrating examples of power saving using various power saving techniques for global dimming LC displays with perceptual impact of one JOD. Table 1000 shows that there may not be power savings for brightness rolloff, whitepoint shift, and color foveation techniques, and the power saving for luminance clipping may be low. The uniform dimming and dichoptic dimming techniques may have better power saving at the loss of one JOD for global dimming LC displays.

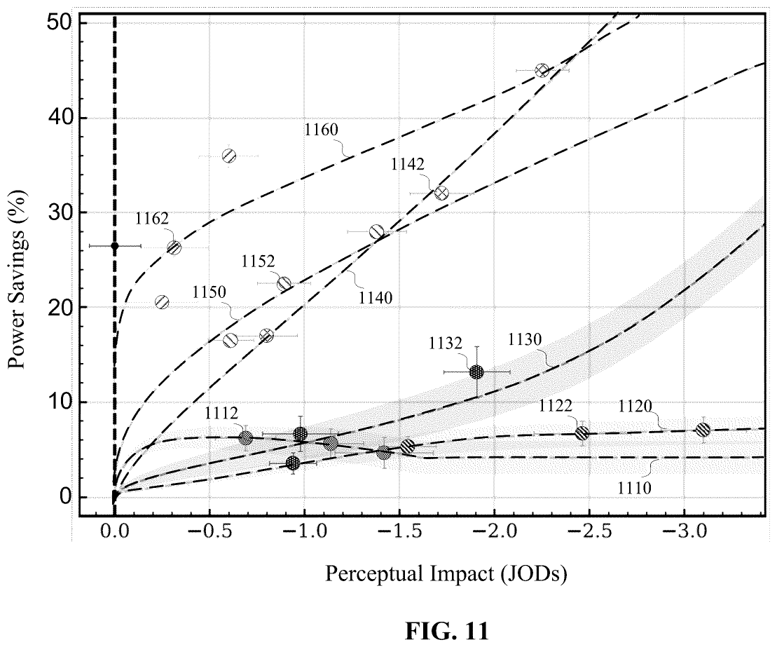

FIG. 11 illustrates examples of transfer functions of perceptual impact versus power saving for local dimming LC displays using various power saving techniques. Data points 1112, 1122, 1132, 1142, 1152, and 1162 represent power savings for different perceptual impacts using the color foveation technique, whitepoint shift technique, luminance clipping technique, uniform dimming technique, dichoptic dimming technique, and brightness rolloff technique, respectively. Horizontal and vertical error bars represent 95% confidence intervals of JOD scores and power savings, respectively. Power savings for techniques such as uniform dimming and dichoptic dimming are content-independent and thus do not exhibit any vertical error bars. Curves 910, 1120, 1130, 1140, 1150, and 1160 are transfer functions of power saving versus perceptual impact for the color foveation technique, whitepoint shift technique, luminance clipping technique, uniform dimming technique, dichoptic dimming technique, and brightness rolloff technique, respectively. Shaded regions in FIG. 11 represent 95% confidence intervals of power savings.

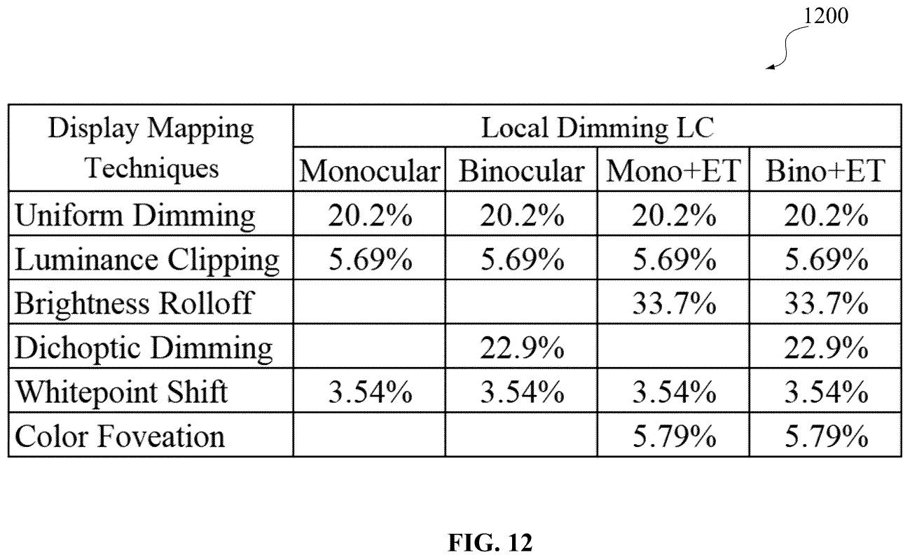

FIG. 12 includes a table 1200 illustrating examples of power saving using various power saving techniques for local dimming LC displays with perceptual impact of one JOD. Table 1200 shows that the uniform dimming technique, brightness rolloff technique, and dichoptic dimming technique may provide higher power saving at the loss of one JOD for local dimming LC displays.

FIGS. 7-12 show that the brightness rolloff may have the lowest perceptual impact for OLED displays and local dimming LC displays across all magnitudes compared to other techniques. Uniform dimming and dichoptic dimming techniques may be device independent and may perform similarly across display types. Whitepoint shift may have the worst perceptual impact among all other techniques at each magnitude level.

Commercial display manufacturers typically choose display primaries which provide good coverage of industry standard color gamuts (e.g., sRGB, DCI-P3). The different sets of color primaries may also affect the display power. It may be desirable to use color primaries that may minimize power consumption and maximizes color accuracy when displaying sRGB images.

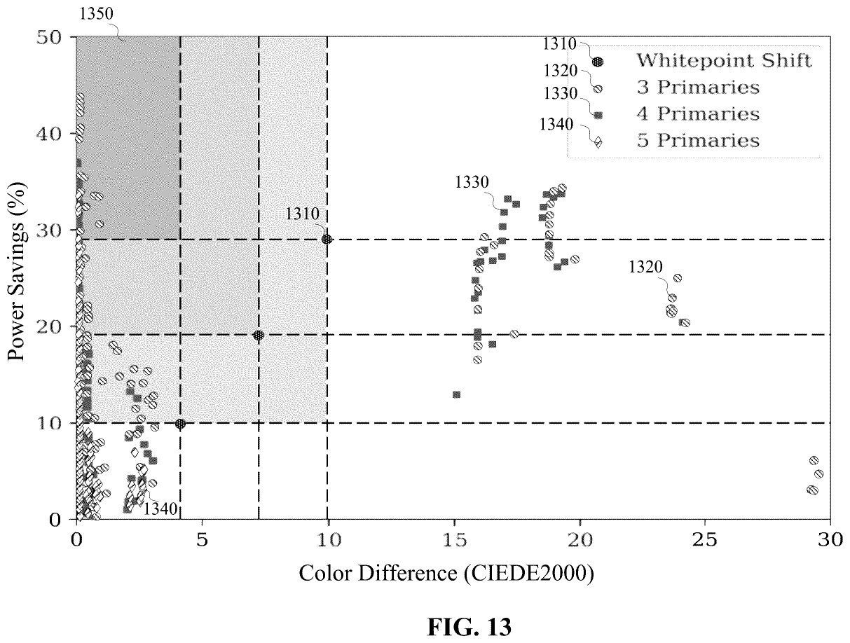

FIG. 13 illustrates examples of color difference and power saving for displaying a set of images using different primaries. In FIG. 13, Display primaries that may introduce non-zero power savings are plotted, with average color difference (CIEDE2000) on the x-axis and mean power savings (in %) on the y-axis, computed on a set of 500 images from the ImageNet dataset. Data points 1310 representing the three whitepoint shift magnitudes used in the studies discussed above with respect to FIGS. 7-12 are plotted for reference. Data points 1320, 1330, and 1340 represent the power savings and color differences for the set of images using 3 primaries, 4 primaries, and 5 primaries, respectively. Data points in a region 1350 at the top left corner of the diagram corresponds to data points having both higher power savings and lower color differences than all three data points 1310. Based on the result shown in FIG. 13, the 4-primary display, which includes an additional blue primary and can covers the sRGB gamut but only extends the gamut marginally, may be selected for power saving.

As described above, brightness rolloff may be a better display mapping technique for OLED and local dimming LC displays. The results shown in FIGS. 7-12 do not include the power consumed by the eye tracking system itself, which can be significant in some display systems.

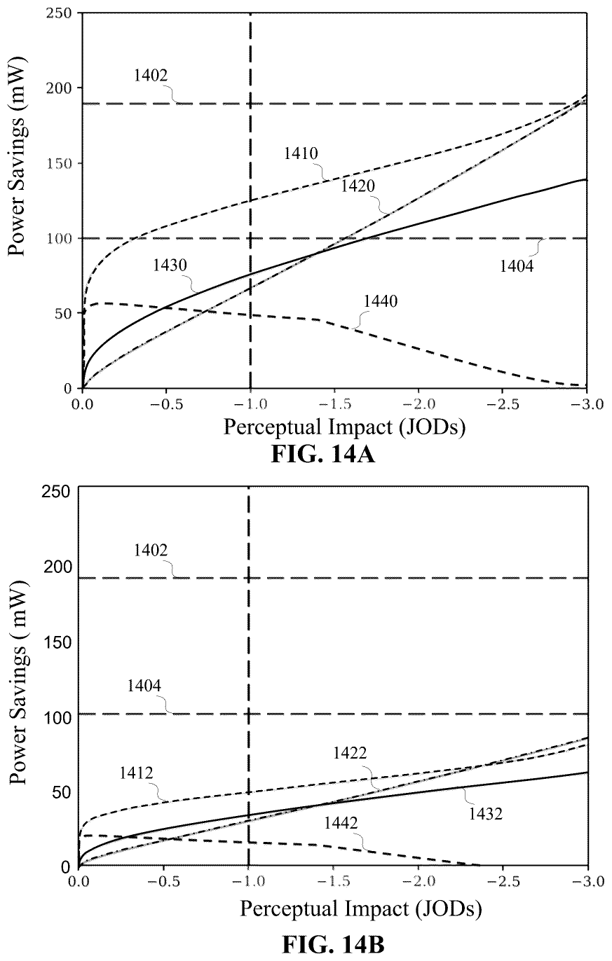

FIG. 14A illustrates examples of power savings in OLED displays using gaze-contingent power saving techniques. In FIG. 14A, a line 1402 shows the power consumption of an example of an eye-tracking system, and a line 1404 shows an example of a target power consumption value of an eye-tracking system. Curves 1410, 1420, and 1430 shows transfer functions of power saving versus perceptual impact in OLED displays using the brightness rolloff, uniform dimming, and dichoptic diming techniques, respectively. A curve 1440 in FIG. 14A shows the difference in power saved between brightness rolloff and the next best method with the same perceptual impact. As illustrated, curve 1440 is below line 1404 and is much lower than line 1402, indicating that the brightness rolloff technique may save less power than non-eye-tracked uniform or dichoptic dimming if power consumption of the eye tracking system is taken into consideration.

FIG. 14B illustrates examples of power savings in local dimming LC displays using gaze-contingent power saving techniques. In FIG. 14A, line 1402 shows the power consumption of an example of an eye-tracking system, and a line 1404 shows an example of a target power consumption value of an eye-tracking system. Curves 1412, 1422, and 1432 shows transfer functions of power saving versus perceptual impact in local dimming LC displays using the brightness rolloff, uniform dimming, and dichoptic diming techniques, respectively. A curve 1442 in FIG. 14B shows the difference in power saved between brightness rolloff and the next best method with the same perceptual impact. As illustrated, curve 1442 is much lower than line 1404 line 1402, indicating that the brightness rolloff technique may save less power than non-eye-tracked uniform or dichoptic dimming if power consumption of the eye tracking system is taken into consideration.

FIGS. 14A and 14B indicate that the brightness rolloff technique may not be justified unless eye tracking is already a system requirement, in which case the brightness rolloff technique may be employed to at least partially offset the power consumption of the eye-tracking system.

Display mapping techniques shown in FIG. 6 may be “hand-crafted” techniques that have been proposed by engineers and scientists over the years based on their intuition and experience. In addition to the display mapping techniques described above, other display mapping techniques, such as different brightness rolloff profiles or combinations of multiple techniques, may also be used. While the above analysis is performed for OLED display and local/global backlit LC displays, similar analysis techniques may be used to determine the transfer functions of power saving versus perceptual impact for other types of display, such as mini/micro-LED or liquid crystal on silicon (LCOS) displays.

In addition, in some embodiments, the analysis technique described above may be automated to evaluate the display power and perceptual performance for a large set of power saving techniques, parameters of the techniques, display types, image types, and the like. In one example, the overall visual difference or distortion between two images may be described using a JOD score as described in, for example, Mantiuk et al., “FovVideoVDP: A visible difference predictor for wide field-of-view video,” ACM Trans. Graph., Vol. 40, No. 4, Article 49 (August 2021). In another example, the visual difference may be described using a differential mean opinion score (DMOS). Using automatic image difference metrics such as JOD scores, DMOS scores, and the like, rather than user study, may enable the analysis of an even larger set of techniques, technique parameters, display types, display content types, and the like, as the perceptual evaluation could be generated automatically for an large number of possibilities.

The display mapping techniques describe above generally explore known aspects of human vision that may allow for a distortion to be not very visible and could save some display power. It may be desirable to avoid limiting the techniques to hand-crafted power saving techniques, as this may limit the potential power savings to only intuitive and obvious editing techniques. According to certain embodiments, a machine learning-based technique may be used to automatically generate images that can save display power while maintaining good visual fidelity to the original image. The machine learning model may be trained to minimize a visual difference between input and output images while maximizing a predicted display power saving, for example, by comparing different image editing techniques for a given display technology using the combined perceptual and power evaluation technique described above.

In one example, a machine learning model such as a neural network model (e.g., a deep artificial neural network or other convolutional neural network architectures) may be trained to minimize perceived visual differences from the original image, while also maximizing the predicted display power savings. The perceived visual differences from the original image may be automatically determined and characterized using, for example, image difference metrics such as JOD, DMOS, peak signal to noise ratio (PSNR), structural similarity index measure (SSIM), mean-square error (MSE), foveated video visual difference predictor (FovVideoVDP), ColorVideo VDP (see, e.g., Mantiuk et al., “ColorVideoVDP: A visual difference predictor for image, video and display distortions,” ACM Trans. Graph., Vol. 43, No. 4, Article 129 (Jul. 19, 2024)), and the like. The display power savings for the target display architecture may also be predicted as described above (e.g., for a set of images or videos). The cost function for training the machine learning model can be given by, for example,

$$COST = a \times P + b \times D ,$$

where a and b are parameters that may be trained or tuned, P is a descriptor that minimizes the visual difference between input and output images, and D is a descriptor that maximizes power savings based on a given target display technology. Descriptor P may include, for example, a distance-based loss such as L1 regulation or L2 regulation, a “perceptual” style ML loss such as Learned Perceptual Image Patch Similarity (LPIPS), or a visual metric such as SSIM, PSNR, FovVideoVDP, or ColorVideo VDP. Experimental results indicate that such a machine learning based method can save significantly more power than hand-crafted techniques, while producing images that are no more visually distorted than those of the hand-crafted techniques.

In one example, images such as high resolution images in the DIV2K dataset may be used as the input images for training the machine learning model. The machine learning model may be, for example, a modified U-NET model. The machine learning model may be trained to tune the parameters of a filter for filtering the input images, such that output images generated by filtering the input images using the filter may minimize visible distortion between input and output images, while maximizing the predicted display power saving. The visible distortion between the input and output images may be any of the P descriptors described above, and may be determined using techniques described above. The power saving may be determined for the target display using the power consumption models for the target display, as described above. The results of the training may be a filter that has the same resolution as the input images. New images to be displayed may be filtered by the filter (e.g., by performing matrix multiplication operations) before being sent to the control circuits of the displays for presenting to the user.

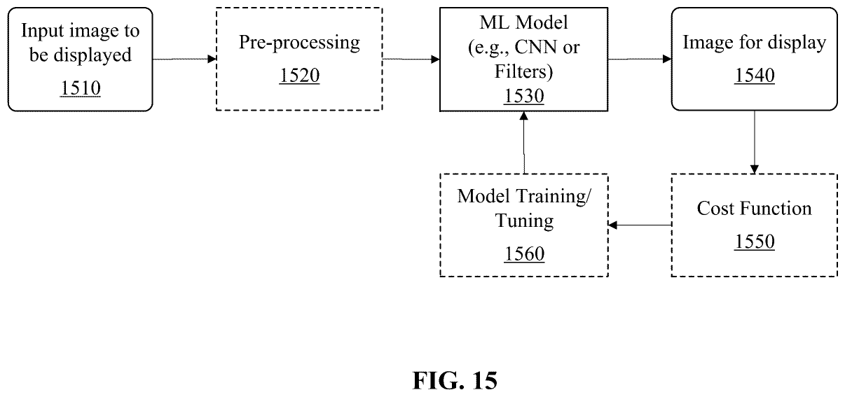

FIG. 15 illustrates an example of using perceptual impact-aware machine learning techniques to edit images to reduce display power according to certain embodiments. In the example shown in FIG. 15, an input image 1510 to be displayed on a display may optionally be processed by a pre-processing engine 1520 so that the image provided to a machine learning model 1530 may meet the requirements of machine learning model 1530, such as the image size, color resolution, number of primary color channels, and the like. Machine learning model 1530 may be a neural network model that includes one or more processing layers with tunable weights. In one example, machine learning model 1530 may include be a filter having the same resolution as the input image, where the coefficients of the filter may need to be tuned. At beginning of the training, the weights or coefficients of machine learning model 1530 may be initialized using default values, random values, or values of a previously trained model. An output image 1540 may be generated by applying machine learning model 1530 to input image 1510 that may optionally be pre-processed by pre-processing engine 1520. Based on input image 1510 and output image 1540, a cost or loss may be determined using a cost function determination engine 1540, which may determine a visual difference between input image 1510 and output image 1540 using metrics and techniques described above, estimate the power saving of display output image 1540 rather than input image 1510, and determine the cost or loss based on a cost function, such as the cost function described above. Based on the determined cost or loss, a model training engine 1560 may determine updated values for at least some weights or coefficients of machine learning model 1530 that may reduce the loss or cost. Once trained, new input images to be displayed may be input into machine learning model 1530, which may generate output images that may maximize display power saving and minimize visible distortion.

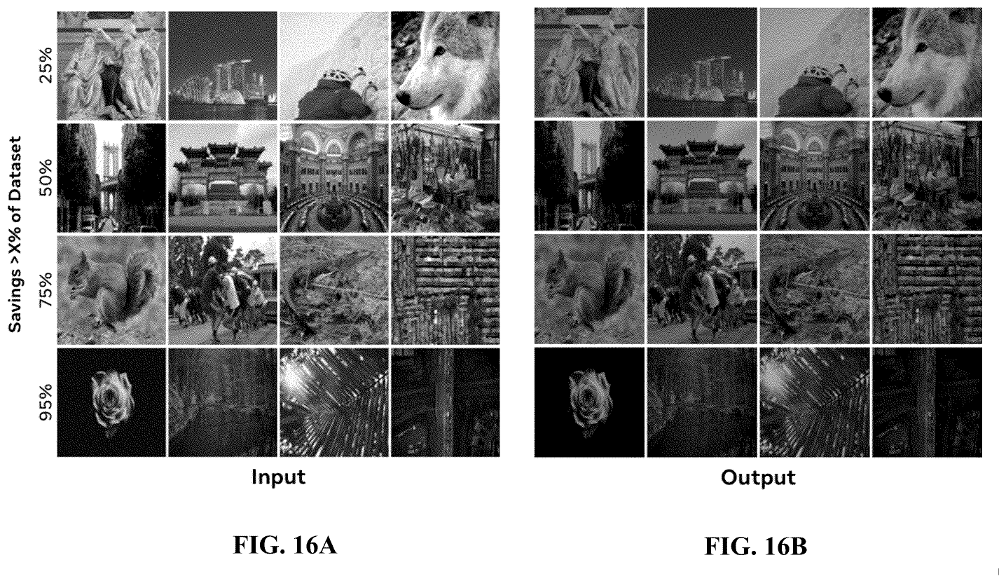

FIG. 16A illustrates examples of input images to a deep neural network for editing images to reduce display power. The input images include images of different brightness and thus different power consumption. FIG. 16B illustrates examples of output images generated by the deep neural network that minimizes visible distortion between input and output images, while maximizing the predicted display power saving, according to certain embodiments.

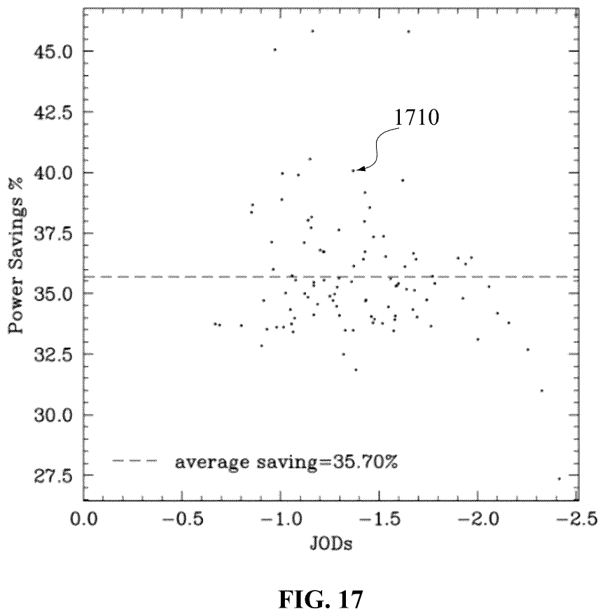

FIG. 17 shows examples of results of the combined perceptual and power analysis of output images generated from input images by a machine learning model according to certain embodiments. For example, the JOD scores and the percentage of power saving for each output image generated by the deep neural network based on the corresponding input images may be automatically determined as described above and plotted at data points 1710 in FIG. 17. In the illustrated example, the results show that an average power saving about 35.7% may be achieved for these input images using the trained deep neural network. Compared to the “hand-crafted” techniques described above, the machine learning-based technique may improve the power saving capabilities of image processing techniques, resulting in more efficient content presentation without causing significant perceptual distortion.

In many display architectures, the display power usage may heavily depend on the content being shown on the display. For example, in an OLED display, the power usage may depend on the combination of the pixel values (e.g., proportional to the mean pixel value). As such, a dimmer image may naturally consume less power than a brighter one. Some colors (e.g., green) may also be more efficient than others (e.g., red) due to, for example, the spectral sensitivity of human eyes. However, when designing content for a certain display (e.g., a VR or AR display, a phone, or a laptop), content creators may not be aware of the power implications of the content they are designing. For example, a content creator may choose to use a red background for an App, even though they could have opted for a green theme instead, without significant loss of the display quality. In another example, a content creator may use a black-on-white text prompt, even though they could have opted for white-on-black text instead, without significant loss of the display quality.

According to certain embodiments, a design tool may be provided to content creators to enable power saving designs during the content creation process. An interface of the design tool may be used to inform content creators of the power profiles of the display content being created and guide the content creators to achieve more power efficient designs when possible. For example, the design tool may evaluate a power profile associated with the display content being designed in terms of power usage (e.g., by providing the estimated amount of power consumption quantitatively or qualitatively) as described above, and may also notify a user regarding design content that may have low power profile scores. In some examples, the design tool may provide to the user suggestions (e.g., swapping a color palette) for improving the power profile, and/or the corresponding perceptual impact (if any), using the automated techniques for evaluating the display power saving and perceptual impact as described above.

In one example, the design tool may evaluate the power profile of a given App and score it on a scale of, for example, 0-100, or qualitatively as bad or good, in terms of power usage. Such information may be helpful to designers and creators for real-time use as they are developing new content. Content that has a better display power profile may allow users to use their devices untethered for longer periods of time, which may be beneficial for the content creators. Applications or interfaces that have poor power usage profiles may be identified and corresponding notifications may be sent to content creators to inform them that the power usage for these applications or interfaces could be improved. In some implementations, automatic suggestions (e.g., color palette swap) may be presented to content creators. In some implementations, techniques such as the machine learning-based techniques described above may be used to provide (real-time) feedback and suggestions to content creators during the content development process. Both global suggestions (e.g., theme or color palette) and local suggestions (e.g., pointing out a certain feature of the content, such as a certain UI element) may be presented to the content creators. For example, the design tool may implement some pre-trained models or filters and may apply the models or filters to the content designed by the creators to generate one or more output images, and the creators may select one from the one or more output images. In some implementations, the design tool may estimate how long an application can run on a particular type of device according to a selected user interface (UI) design (e.g., 40 minutes for a first UI design, 55 minutes for a second UI design, etc.) and present the estimated run time to the content creators. In some embodiments, the design tool may calculate an image difference metric of a new design with respect to an original design.

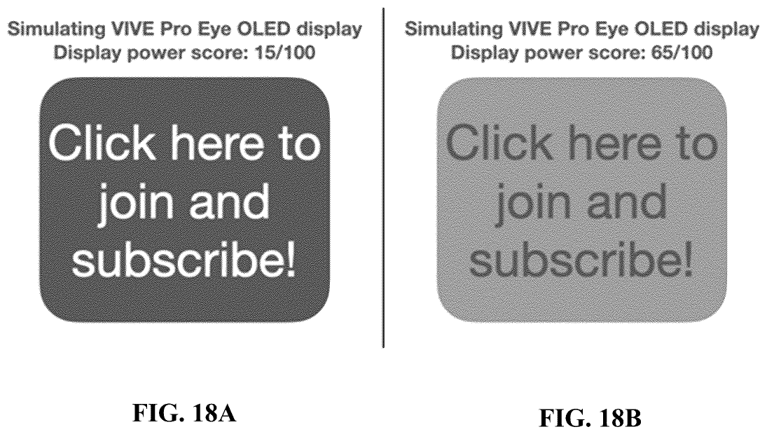

FIGS. 18A and 18B illustrate examples of implementations of a design tool that provides display power scores and/or recommendations to content creators during display content design according to certain embodiments. As described above, the display type may play a significant role in power consumption. For example, some display architectures may have lower efficiencies for generating light of some colors (e.g., micro-LEDs emitting red light may be less efficient than micro-LEDs emitting green or blue light), and human eyes may be more sensitive to some colors (e.g., green light) than other colors (e.g., red light) of the same emission power/energy. A flag may be raised if one particular type or architecture of display has a poor power profile for a given piece of content being produced. In some implementations, the design tool may provide global and/or local suggestions to the content creators. In this way, the design tool may enable the content creators to ensure their content is a good match for the specific display type and audiences (e.g., using Instagram on phones vs. using it on AR displays).

The example illustrated in FIG. 18A shows a simple implementation of displaying a display power score for content creators as they design a UI element for an App. The design shown in FIG. 18A may use a theme, colors, and/or brightness levels that may not be optimal for the target display. For example, using red as the background color and white text may be less power efficient than using green as the background color and black text. The design tool may estimate the power consumption for displaying the designed display content on an OLED display, and provide an estimated display power score (e.g., 15 out of 100) on a user interface, such that the content creator may be aware of and make changes to improve the display power score.

The example illustrated in FIG. 18B shows a simple implementation of providing suggestions or recommendations for improving the display power score to content creators as they design a UI element for an App. In the illustrated example, the design tool may, after determining that the design shown in FIG. 18A may use a theme, colors, and/or brightness levels that may not be optimal for the target display, suggest that the content creator changes the design, for example, by changing the background color to green, and may also provide the display power score for the suggested design. In some implementations, more comprehensive recommendations related to global features (e.g., theme or color palette) and local features (elements) of the design content (e.g., images or videos) may be provided to the content creator by the design tool.

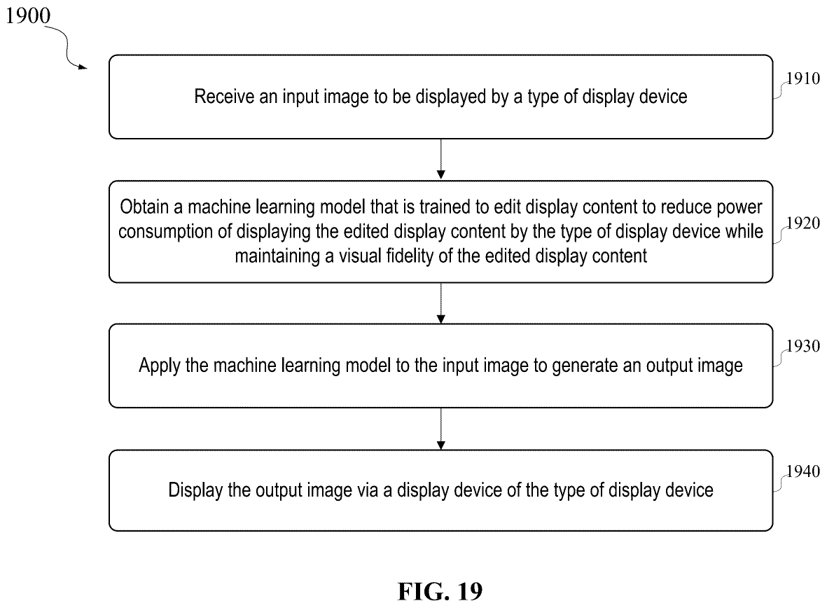

FIG. 19 includes a flowchart 1900 illustrating an example of a process of editing an image to reducing the power consumption for displaying the image while maintaining a visual fidelity of the edited display content. Although flowchart 1900 may describe the operations as a sequential order, some of the operations may be performed in parallel or concurrently. In addition, the order of the operations may be rearranged. The process may have additional steps not included in the flowchart. Some operations may be optional or may be omitted in some implementations. Some operations may be performed more than one time. Some operations may each include multiple sub-operations. Some operations in different blocks may be combined and performed using a same device, processing engine, computer program, machine learning model, or functional module.

Operations in block 1910 may include receiving an input image to be displayed by a type of display device. The type of display device may include a global dimming liquid crystal display (LCD) device, a local dimming LCD device, an organic light emitting diode (OLED) display device, an inorganic light emitting diode (ILED) display device, a micro-OLED display device, a micro-light emitting diode (micro-LED) display device, a liquid crystal on silicon (LCOS) display device, an active-matrix OLED display (AMOLED) device, a laser-based display device, a DLP display device, or a transparent OLED display (TOLED) device.

Operations in block 1920 may include obtaining a machine learning model that is trained to edit display content to reduce power consumption of displaying the edited display content by the type of display device while maintaining a visual fidelity of the edited display content. The machine learning model may be trained using a cost function that is a function of both a power saving and a perceptual impact of displaying the edited display content, instead of the display content, on the type of display device. For example, the cost function may be:

$$COST = a \times P + b \times D ,$$

where P is indicative of a visual difference between the display content and the edited display content, D is indicative of a power saving for displaying the edited display content instead of the display content, and a and b are coefficients of P and D, respectively. Obtaining the machine learning model may include selecting the machine learning model from a plurality of machine learning models trained for a plurality of types of display device. The machine learning model is configured to change one or more global features of the display content (e.g., theme or color palette), one or more local features (pixels or elements) of the display content, or a combination thereof. In some examples, the machine learning model may include a neural network model or a filter, such as a filter having a same resolution as the input image. The visual fidelity may be indicated by a just-objectionable-difference (JOD) score, a differential mean opinion score (DMOS), a peak signal to noise ratio (PSNR), a structural similarity index measure (SSIM), or a foveated video visual difference predictor (FovVideo VDP).

Operations in block 1930 may include applying the machine learning model to the input image to generate an output image. For example, the machine learning model may receive the input image as inputs and generate the output image using one or more neural network layers. When the trained machine model includes a filter, the output image may be generated by multiplying the input image with the filter using, for example, matrix multiplication. Operations in block 1940 may include displaying the output image via a display device of the type of display device. Display the output image may consume less power than displaying the input image, and the output image may maintain a visual fidelity of the input image (e.g., with a perceptual difference less than a threshold JOD value).

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

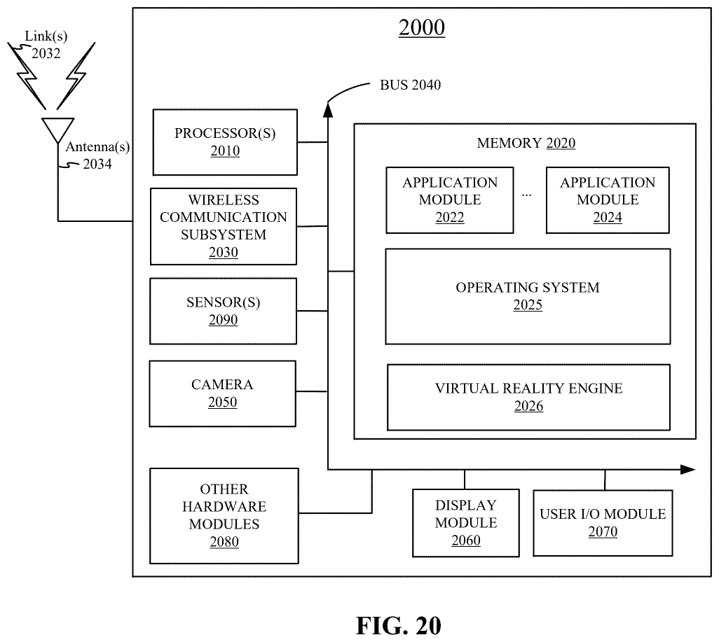

FIG. 20 is a simplified block diagram of an example electronic system 2000 of an example near-eye display (e.g., HMD device) for implementing some of the examples disclosed herein. Electronic system 2000 may be used as the electronic system of an HMD device or other near-eye displays described above. In this example, electronic system 2000 may include one or more processor(s) 2010 and a memory 2020. Processor(s) 2010 may be configured to execute instructions for performing operations at a number of components, and can be, for example, a general-purpose processor or microprocessor suitable for implementation within a portable electronic device. Processor(s) 2010 may be communicatively coupled with a plurality of components within electronic system 2000. To realize this communicative coupling, processor(s) 2010 may communicate with the other illustrated components across a bus 2040. Bus 2040 may be any subsystem adapted to transfer data within electronic system 2000. Bus 2040 may include a plurality of computer buses and additional circuitry to transfer data.

Memory 2020 may be coupled to processor(s) 2010. In some embodiments, memory 2020 may offer both short-term and long-term storage and may be divided into several units. Memory 2020 may be volatile, such as static random access memory (SRAM) and/or dynamic random access memory (DRAM) and/or non-volatile, such as read-only memory (ROM), flash memory, and the like. Furthermore, memory 2020 may include removable storage devices, such as secure digital (SD) cards. Memory 2020 may provide storage of computer-readable instructions, data structures, program modules, and other data for electronic system 2000.

In some embodiments, memory 2020 may store a plurality of application modules 2022 through 2024, which may include any number of applications. Examples of applications may include gaming applications, conferencing applications, video playback applications, or other suitable applications. The applications may include a depth sensing function or eye tracking function. Application modules 2022-2024 may include particular instructions to be executed by processor(s) 2010. In some embodiments, certain applications or parts of application modules 2022-2024 may be executable by other hardware modules 2080. In certain embodiments, memory 2020 may additionally include secure memory, which may include additional security controls to prevent copying or other unauthorized access to secure information.

In some embodiments, memory 2020 may include an operating system 2025 loaded therein. Operating system 2025 may be operable to initiate the execution of the instructions provided by application modules 2022-2024 and/or manage other hardware modules 2080 as well as interfaces with a wireless communication subsystem 2030 which may include one or more wireless transceivers. Operating system 2025 may be adapted to perform other operations across the components of electronic system 2000 including threading, resource management, data storage control and other similar functionality.

Wireless communication subsystem 2030 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 2000 may include one or more antennas 2034 for wireless communication as part of wireless communication subsystem 2030 or as a separate component coupled to any portion of the system. Depending on desired functionality, wireless communication subsystem 2030 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 2030 may permit data to be exchanged with a network, other computer systems, and/or any other devices described herein. Wireless communication subsystem 2030 may include a means for transmitting or receiving data, such as identifiers of HMD devices, position data, a geographic map, a heat map, photos, or videos, using antenna(s) 2034 and wireless link(s) 2032.

Embodiments of electronic system 2000 may also include one or more sensors 2090. Sensor(s) 2090 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor.

Electronic system 2000 may include a display module 2060. Display module 2060 may be a near-eye display, and may graphically present information, such as images, videos, and various instructions, from electronic system 2000 to a user. Such information may be derived from one or more application modules 2022-2024, virtual reality engine 2026, one or more other hardware modules 2080, a combination thereof, or any other suitable means for resolving graphical content for the user (e.g., by operating system 2025). Display module 2060 may use LCD technology, LED technology (including, for example, OLED, ILED, u-LED, AMOLED, TOLED, etc.), light emitting polymer display (LPD) technology, or some other display technology.

Electronic system 2000 may include a user input/output module 2070. User input/output module 2070 may allow a user to send action requests to electronic system 2000. An action request may be a request to perform a particular action. For example, an action request may be to start or end an application or to perform a particular action within the application. User input/output module 2070 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 2000. In some embodiments, user input/output module 2070 may provide haptic feedback to the user in accordance with instructions received from electronic system 2000. For example, the haptic feedback may be provided when an action request is received or has been performed.

Electronic system 2000 may include a camera 2050 that may be used to take photos or videos of a user, for example, for tracking the user's eye position. Camera 2050 may also be used to take photos or videos of the environment, for example, for VR, AR, or MR applications. Camera 2050 may include, for example, a complementary metal-oxide-semiconductor (CMOS) image sensor with a few millions or tens of millions of pixels. In some implementations, camera 2050 may include two or more cameras that may be used to capture 3-D images.

In some embodiments, electronic system 2000 may include a plurality of other hardware modules 2080. Each of other hardware modules 2080 may be a physical module within electronic system 2000. While each of other hardware modules 2080 may be permanently configured as a structure, some of other hardware modules 2080 may be temporarily configured to perform specific functions or temporarily activated. Examples of other hardware modules 2080 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 2080 may be implemented in software.

In some embodiments, memory 2020 of electronic system 2000 may also store a virtual reality engine 2026. Virtual reality engine 2026 may execute applications within electronic system 2000 and receive position information, acceleration information, velocity information, predicted future positions, or any combination thereof of the HMD device from the various sensors. In some embodiments, the information received by virtual reality engine 2026 may be used for producing a signal (e.g., display instructions) to display module 2060. For example, if the received information indicates that the user has looked to the left, virtual reality engine 2026 may generate content for the HMD device that mirrors the user's movement in a virtual environment. Additionally, virtual reality engine 2026 may perform an action within an application in response to an action request received from user input/output module 2070 and provide feedback to the user. The provided feedback may be visual, audible, or haptic feedback. In some implementations, processor(s) 2010 may include one or more GPUs that may execute virtual reality engine 2026.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, etc.

In this description, the recitation “based on” means “based at least in part on.” Therefore, if X is based on Y, then X may be a function of at least a part of Y and any number of other factors. If an action X is “based on” Y, then the action X may be based at least in part on at least a part of Y.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A computer-implemented method comprising:
receiving an input image to be displayed by a type of display device;
obtaining a machine learning model that is trained to edit display content to reduce power consumption of displaying the edited display content by the type of display device while maintaining a visual fidelity of the edited display content;
applying the machine learning model to the input image to generate an output image; and
displaying the output image via a display device of the type of display device.

2. The computer-implemented method of claim 1, wherein the machine learning model is trained using a cost function that is a function of both a power saving and a perceptual impact of displaying the edited display content, instead of the display content, on the type of display device.

3. The computer-implemented method of claim 2, wherein the cost function is COST=a×P+b×D, where P is indicative of a visual difference between the display content and the edited display content, D is indicative of a power saving for displaying the edited display content instead of the display content, and a and b are coefficients of P and D, respectively.

4. The computer-implemented method of claim 1, wherein obtaining the machine learning model comprises selecting the machine learning model from a plurality of machine learning models trained for a plurality of types of display device.

5. The computer-implemented method of claim 1, wherein the machine learning model is configured to change one or more global features of the display content, one or more local features of the display content, or a combination thereof.

6. The computer-implemented method of claim 1, wherein the machine learning model includes a neural network model or a filter.

7. The computer-implemented method of claim 1, wherein the machine learning model includes a filter having a same resolution as the input image.

8. The computer-implemented method of claim 1, wherein the visual fidelity is indicated by a just-objectionable-difference (JOD) score, a differential mean opinion score (DMOS), a peak signal to noise ratio (PSNR), a structural similarity index measure (SSIM), or a foveated video visual difference predictor (Fov Video VDP).

9. The computer-implemented method of claim 1, wherein the type of display device includes a global dimming liquid crystal display (LCD) device, a local dimming LCD device, an organic light emitting diode (OLED) display device, an inorganic light emitting diode (ILED) display device, a micro-OLED display device, a micro-light emitting diode (micro-LED) display device, a liquid crystal on silicon (LCOS) display device, an active-matrix OLED display (AMOLED) device, a laser-based display device, a digital light processing (DLP) display device, or a transparent OLED display (TOLED) device.

10. The computer-implemented method of claim 1, wherein the display content includes one or more images, one or more videos, or a combination thereof.

11. A computer-implemented method comprising:
determining a power profile associated with display content being designed, the power profile indicating a quantitative or qualitative power consumption for displaying the display content on a type of display device;
displaying, via a user interface, the power profile associated with the display content;
identifying a modification to the display content to reduce power consumption for displaying the display content on the type of display device; and
providing, via the user interface, a recommendation to make the modification to the display content.

12. The computer-implemented method of claim 11, wherein the modification includes modifying one or more global features, modifying one or more local features, or modifying one or more global features and one or more local features.

13. The computer-implemented method of claim 11, further comprising presenting, on the user interface, an image difference metric of a modified version of the display content with respect to an original version of the display content.

14. The computer-implemented method of claim 13, wherein the image difference metric includes a just-objectionable-difference (JOD) score, a differential mean opinion score (DMOS), a peak signal to noise ratio (PSNR), a structural similarity index measure (SSIM), or a foveated video visual difference predictor (FovVideoVDP).

15. The computer-implemented method of claim 11, further comprising presenting, on the user interface, a power profile associated with a modified version of the display content 2 with the modification.

16. The computer-implemented method of claim 11, wherein the power profile of the display content includes a power efficiency score for displaying the display content on the type 2 of display device.

17. The computer-implemented method of claim 11, wherein the power profile of the display content includes a battery life for displaying the display content on the type of display device.

18. The computer-implemented method of claim 11, wherein:
identifying the modification to the display content comprises applying a machine learning model on the display content, wherein the machine learning model is trained to modify the display content to reduce power consumption of displaying the display content by the type of display device while maintaining a visual fidelity of the display content.

19. The computer-implemented method of claim 18, wherein the machine learning model is trained using a cost function that is a function of both a power saving and a perceptual impact of displaying the edited display content, instead of the display content, on the type of display device.

20. The computer-implemented method of claim 11, wherein the type of display device includes a global dimming liquid crystal display (LCD) device, a local dimming LCD device, an organic light emitting diode (OLED) display device, an inorganic light emitting diode (ILED) display device, a micro-OLED display device, a micro-light emitting diode (micro-LED) display device, a liquid crystal on silicon (LCOS) display device, an active-matrix OLED display (AMOLED) device, a laser-based display device, a digital light processing (DLP) display device, or a transparent OLED display (TOLED) device.
